(19) United States
(12) Patent Application Publication
(10) Pub. No.: US 2006/0164037 A1
(43) Pub. Date: Jul. 27, 2006

(54) Portable charger

(76) Inventor: Li Chin Kuo, ShenZhen City (CN)

Correspondence Address: Raymond Y. Chan, 108 N. Ynez Ave. #128,, Monterey Park, CA, 91754, US

(21) Appl. No.: 11/042,646

(22) Filed: Jan. 24, 2005

(51) Int. Cl. H02J 7/00

(52) U.S. Cl. 320/115

(57) ABSTRACT

A portable charger includes a hand crank power generator adapted for generating an AC current and a DC conversion arrangement including an excitation rectifier electrically connecting to the hand crank power generator for rectifying the AC current to an undulate sine wave DC current, an oscillator circuit converting the undulate sine wave DC current into an undulate square wave DC current, a ballast filter circuit modifying the undulate square wave DC current to minimize a ripple thereof so as to form a modified square wave DC, a voltage regulator regulating the modified square wave DC to the stable DC current at an operation voltage, and a pulse DC current generator generating a short pulse-width DC current for allowing the stable DC current to power up the electric appliance.

### BACKGROUND OF THE PRESENT INVENTION

1. Field of Invention

The present invention relates to a charging device, and more particularly to a portable charger adapted for providing a constant power output by man-power so as to charge up an electronic appliance for traveling, outdoors, or emergency.

2. Description of Related Arts

With the mature and expeditious development of the electronics technology, the electric appliances alter the living standard of the human beings into a better environment and greatly improve the welfare of mankind. Such electric appliances, such as mobile phone, PDA (Personal Digital Assistance), MP3 player, or notebook, could be easily found in the pocket of the user. However, once the electric appliance is out of battery, the convenience of the electric appliance becomes a hassle for the user that where the electric appliance can be recharged. In other words, the low-battery warning frustrates the user frequently. For instance, during the presentation, in the middle of celebration, on the need for data inquiry, or for the emergent calling, the electric appliance fails to operate if there is no power at all. These perplexities would usually result in great loss, either monetarily or emotionally. The limitation of the price and size of the battery restrains the possibility of bringing along more batteries for every single electric appliance and the recharging apparatus should not be expected wherever.

The state-of-the-art solutions for the portable power issue are either increasing the battery volume and modifying the power conversion circuit, or replacing the rechargeable battery with dry battery so as to bypass the charging problem. Notwithstanding the above proposals, the drawbacks are obvious. With the additional function such as using the LED (Light Emitting Diode) adding on to the charger, it offers lighting function to the charger, nevertheless, the pitfall still exists: charging ability. The hand generator is another possible solution for the portable charging issue. However, such hand generator is not able to supply the modern sophisticated electric device with good quality and consistent power. It is crucial to find a charging solution which could apply to every occasion and still offer the great facilitation and broad range of applicability to the electric appliances.

### SUMMARY OF THE PRESENT INVENTION

A main object of the present invention is to provide a portable charger, wherein the special designed hand generator provides high quality direct current power and with multiple supplementary functions, the present invention is ideal all-in-one charger for the outdoors, traveling, or emergent situation.

Another object of the present invention is to provide a portable charger, which comprises a DC conversion arrangement for regulating an unstable current output from a hand crank power generator to a stable DC current for charging any electric appliance requiring a high quality DC current input.

Another object of the present invention is to provide a portable charger, which comprises an internal electrical storage for supplying electrical power to the electric appliance while the internal electrical storage is adapted to be charged up by the hand crank power generator.

Another object of the present invention is to provide a portable charger, which comprises a low current monitor circuit for monitoring the voltage level of the internal electrical storage so as to ensure the power output to the electric appliance.

Another object of the present invention is to provide a portable charger, which comprises an emergence illumination circuit arranged to generate an alert signal so as to indicate the existence of a hazardous situation.

Another of the present invention is to provide a portable charger, which has a compact size for easily storage and carriage.

Accordingly, in order to accomplish the above objects, the present invention provides a portable charger for charging an electric appliance, comprising a hand crank power generator adapted for generating an AC current and a DC conversion arrangement, which is arranged for regulating the AC current to a stable DC current for the electric appliance.

The DC conversion arrangement comprises an excitation rectifier electrically connecting to the hand crank power generator for rectifying the AC current to an undulate sine wave DC current, an oscillator circuit converting the undulate sine wave DC current into an undulate square wave DC current, a ballast filter circuit modifying the undulate square wave DC current to minimize a ripple thereof so as to form a modified square wave DC, a voltage regulator regulating the modified square wave DC to the stable DC current at an operation voltage, and a pulse DC current generator generating a short pulse-width DC current for allowing the stable DC current outputting to power up the electric appliance.

These and other objectives, features, and advantages of the present invention will become apparent from the following detailed description, the accompanying drawings, and the appended claims.

### BRIEF DESCRIPTION OF THE DRAWINGS

FIG. 1 is the block diagram of the portable charger according to a preferred embodiment of the present invention.

FIG. 2 is the circuit diagram of the portable charger according to the above preferred embodiment of the present invention.

### DETAILED DESCRIPTION OF THE PREFERRED EMBODIMENTS

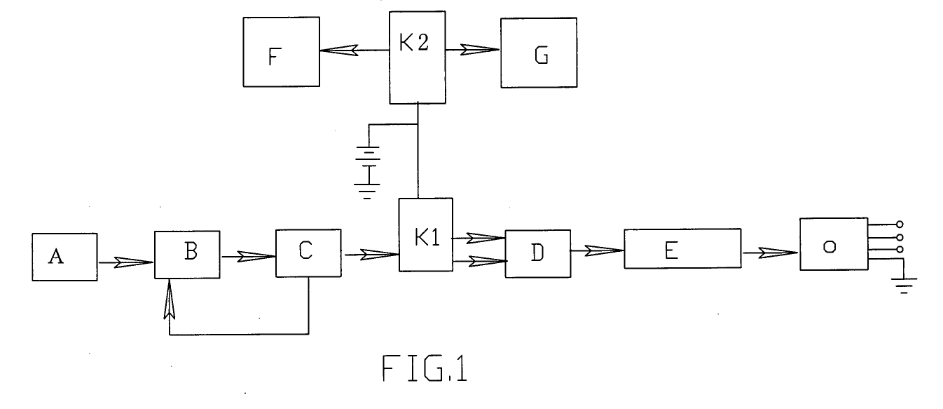

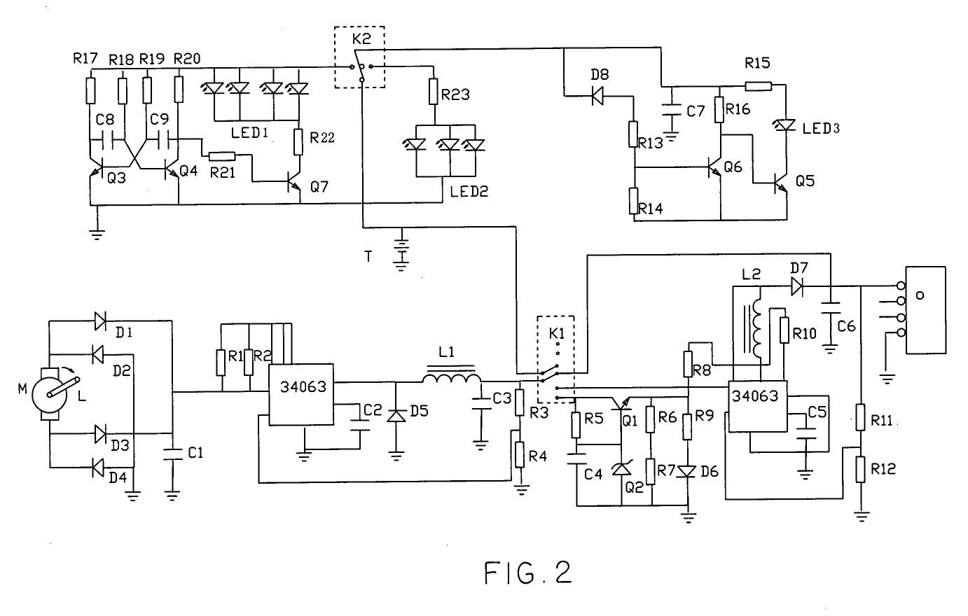

Referring to FIGS. 1 and 2 of the drawings, a portable charger for charging an electric appliance is illustrated, wherein the electric appliance, such as the MP3 player, the laptop, the mobile phone, or the PDA, requires the quality of the power supply to be recharged. It is worth to mention that the conventional hand generator with a normal rectifier provides an unstable and inconsistent power supply which would results in poor charging efficiency or even permanent damage to the electric device if the electric appliance is directly connected to the generator. The possible loss of the damage to the property surpasses the benefit and convenience that the conventional charger offers.

According to the preferred embodiment, the portable charger comprises a hand crank power generator M adapted for generating an AC current; and a DC conversion arrangement for regulating the AC current to a stable DC current for the electric appliance. Accordingly, the DC conversion arrangement has voltage divider output O adapted for electrically connecting with an input of the electric appliance so as to input the stable DC current for the electric appliance at the voltage divider output O.

The portable charger further comprises a portable casing housing the hand crank power generator M therein wherein the hand crank power generator M comprises a hand crank L rotatably supported by the portable casing to actuate the hand crank power generator M for generating the AC current with respect to the rotational cranking action of the hand crank L.

The DC conversion arrangement comprises an excitation rectifier A electrically connecting to the hand crank power generator for rectifying the AC current to an undulate sine wave DC current, an oscillator circuit B converting the undulate sine wave DC current into an undulate square wave DC current, a ballast filter circuit C modifying the undulate square wave DC current to minimize a ripple thereof so as to form a modified square wave DC, a voltage regulator D regulating the modified square wave DC to the stable DC current at an operation voltage, and a pulse DC current generator E generating a short pulse-width DC current for allowing the stable DC current outputting to power up the electric appliance.

Accordingly, the excitation rectifier A is a full-wave bridge rectifier comprising four diodes D1, D2, D3 and D4, and with a capacitor C1. The excitation rectifier A regulates the AC current produced by the hand crank power generator M into the undulate DC current due to the slightly voltage drop resulting from the fact that the current passes through two diodes in each half cycle and the discharging current on the capacitor C1.

The output of the excitation rectifier A (i.e. the undulate sine wave DC current) connects to the oscillator circuit B which comprises the integrated circuit 34063, two resistors R1 and R2, and two capacitors C1 and C2, wherein the oscillator circuit B regulates the undulate direct current into square-wave interval direct current.

The ballast filter circuit C comprises the inductor L1, the diode D5 and the capacitor C3 to provide the function of π-type freewheeling filter circuit which improves the stability and reduce the ripples of the square-wave direct current. The voltage divider comprises two resistors R3 and R4 provides the feedback voltage connecting to the oscillator circuit B in order to guarantee the quality of the square-wave direct current. The above process insure the current is stable and the voltage is regulated in the desired range of variation, wherein the current subsequently connects to the switch K1, switching between the switch K2 and the voltage regulator circuit D.

The voltage regulator circuit D comprises a NPN transistor Q1, a controlled diode Q2, three resistors R5, R6 and R7, and a capacitor C4. The square-wave interval direct current from the ballast filter circuit C has a standard operating voltage and the stable current which could be the power supply, through the switch K1, to charge an internal electrical storage T in the portable casing. Accordingly, the internal electrical storage T is a rechargeable battery to store the electrical energy from the DC conversion arrangement. In other words, the electrical energy from the DC conversion arrangement is adapted to either charge the internal electrical storage T or the electric appliance via the switch K1. Once the internal electrical storage T is charged up, the internal electrical storage T supplies the electrical energy to charge the electric appliance without operating the hand crank power generator M. Therefore, the user is able to pre-store the electrical energy in the internal electrical storage T by operating the hand crank power generator M to charge the electric appliance.

Accordingly, the portable charger further comprises a low voltage monitor circuit F for monitoring the voltage level of the internal electrical storage T so as to ensure the power output to the electric appliance. The low voltage monitor circuit F comprises two transistors Q5 and Q6, a diode D8, four resistors R13, R14, R15 and R16, a capacitor C7, and a LED3, to provide the function of the compound amplifier. In other words, the low voltage monitor circuit F detects the capacity of the internal electrical storage T and send a low voltage signal when the electrical energy stored in the internal electrical storage T is below a predetermined usage level.

The pulse direct current generator circuit E, which is electrically connected to the voltage divider output O, comprises two blocks: the square-wave generator consisting of a integrated circuit 34064, two resistors R8 and R9, a diode D6, and a capacitor C5, and a filter rectifier consisting of a resistor R10, a inductor L2, a diode D7 and a capacitor C6, wherein the voltage divider by the R11 and the R12 provides the feedback voltage to a PIN 5 at the integrated circuit 34064.

The portable charger further comprises an emergence illumination circuit G arranged to generate an alert signal so as to indicate the existence of a hazardous situation. Accordingly, the emergence illumination circuit G comprises a plurality of illuminators electrically connecting with the DC conversion arrangement and the internal electrical storage T wherein the illuminators are adapted for generating lights as the alert signal. The illuminators are embodied as the high-brightness red LED1 and the high-brightness white LED2 to generate the flashing lights. The emergent illumination circuit G comprises two transistors Q3 and Q4, four resistors R17, R18, R19 and R20, and two capacitors C8 and C9, to provide the function of the oscillator, and a transistor Q7 and two resistors R20 and R21 to provide the function of the amplifier with a loading of the high-brightness red LED1, and the high-brightness white LED2 is connected to the internal electrical storage T through the switch K2. Therefore, emergence illumination circuit G sends emergent situation signal, flashing or lightening effect by a set of high brightness LEDs.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable charger for charging an electric appliance, comprising:
a portable casing;
a hand crank power generator housed in said portable casing for generating an AC current; and
a DC conversion arrangement, which is arranged for regulating said AC current to a stable DC current for said electric appliance, comprising:
an excitation rectifier electrically connecting to said hand crank power generator for rectifying said AC current to an undulate sine wave DC current;
an oscillator circuit converting said undulate sine wave DC current into an undulate square wave DC current;
a ballast filter circuit modifying said undulate square wave DC current to minimize a ripple thereof so as to form a modified square wave DC;
a voltage regulator regulating said modified square wave DC to said stable DC current at an operation voltage; and
a pulse DC current generator generating a short pulse-width DC current for allowing said stable DC current outputting said electric appliance so as to power up said electric appliance.

2. The portable charger, as recited in claim 1, wherein said excitation rectifier comprises a full-wave bridge rectifier having four diodes and a capacitor that said AC current passes through said diodes in each half cycle and discharges through said capacitor.

3. The portable charger, as recited in claim 1, wherein said ballast filter circuit, which provides a function of π-type freewheeling filter circuit which improves the stability and reduce the ripples of the square-wave direct current, comprises a voltage divider providing a feedback voltage connecting to said oscillator circuit in order to guarantee the quality of said square-wave direct current.

4. The portable charger, as recited in claim 2, wherein said ballast filter circuit, which provides a function of π-type freewheeling filter circuit which improves the stability and reduce the ripples of the square-wave direct current, comprises a voltage divider providing a feedback voltage connecting to said oscillator circuit in order to guarantee the quality of said square-wave direct current.

5. The portable charger, as recited in claim 1, further comprising an internal electrical storage housed in said portable casing and electrically connecting to said DC conversion arrangement, wherein said internal electrical storage stores electrical energy generated by said hand crank power generator through said DC conversion arrangement for charging said electric appliance.

6. The portable charger, as recited in claim 2, further comprising an internal electrical storage housed in said portable casing and electrically connecting to said DC conversion arrangement, wherein said internal electrical storage stores electrical energy generated by said hand crank power generator through said DC conversion arrangement for charging said electric appliance.

7. The portable charger, as recited in claim 4, further comprising an internal electrical storage housed in said portable casing and electrically connecting to said DC conversion arrangement, wherein said internal electrical storage stores electrical energy generated by said hand crank power generator through said DC conversion arrangement for charging said electric appliance.

8. The portable charger, as recited in claim 5, further comprising a low voltage monitor circuit monitoring a voltage level of said internal electrical storage for ensuring a power output to said electric appliance.

9. The portable charger, as recited in claim 6, further comprising a low voltage monitor circuit monitoring a voltage level of said internal electrical storage for ensuring a power output to said electric appliance.

10. The portable charger, as recited in claim 7, further comprising a low voltage monitor circuit monitoring a voltage level of said internal electrical storage for ensuring a power output to said electric appliance.

11. The portable charger, as recited in claim 1, further comprising an emergence illumination circuit for generating an alert signal so as to indicate the existence of a hazardous situation, wherein said emergence illumination circuit comprises a plurality of illuminators electrically connecting with said DC conversion arrangement for generating flashing lights as said alert signal.

12. The portable charger, as recited in claim 4, further comprising an emergence illumination circuit for generating an alert signal so as to indicate the existence of a hazardous situation, wherein said emergence illumination circuit comprises a plurality of illuminators electrically connecting with said DC conversion arrangement for generating flashing lights as said alert signal.

13. The portable charger, as recited in claim 7, further comprising an emergence illumination circuit for generating an alert signal so as to indicate the existence of a hazardous situation, wherein said emergence illumination circuit comprises a plurality of illuminators electrically connecting with said DC conversion arrangement for generating flashing lights as said alert signal.

14. The portable charger, as recited in claim 10, further comprising an emergence illumination circuit for generating an alert signal so as to indicate the existence of a hazardous situation, wherein said emergence illumination circuit comprises a plurality of illuminators electrically connecting with said DC conversion arrangement for generating flashing lights as said alert signal.

15. A method for converting an AC current into a stable DC current, comprising the steps of:
(a) rectifying said AC current to an undulate sine wave DC current;
(b) converting said undulate sine wave DC current into an undulate square wave DC current;
(c) modifying said undulate square wave DC current to minimize a ripple thereof so as to form a modified square wave DC; and
(d) regulating said modified square wave DC to said stable DC current at an operation voltage.

16. The method as recited in claim 15, further comprising a step (e) of generating a short pulse-width DC current to said stable DC current.

17. The method as recited in claim 16, in step (c), further comprising the sub-steps of:
(c.1) providing a function of π-type freewheeling filter circuit which improves the stability and reduce the ripples of said square-wave direct current, and
(c.2) providing a feedback voltage connecting to said oscillator circuit in order to guarantee the quality of said square-wave direct current.

18. The method, as recited in claim 15, wherein the step (a) is performed by a full-wave bridge rectifier having four diodes and a capacitor that said AC current passes through said diodes in each half cycle and discharges through said capacitor.

19. The method, as recited in claim 16, wherein the step (a) is performed by a full-wave bridge rectifier having four diodes and a capacitor that said AC current passes through said diodes in each half cycle and discharges through said capacitor.

20. The method, as recited in claim 17, wherein the step (a) is performed by a full-wave bridge rectifier having four diodes and a capacitor that said AC current passes through said diodes in each half cycle and discharges through said capacitor.
